(19) United States
(12) Patent Application Publication
(10) Pub. No.: US 2010/0292991 A1
(43) Pub. Date: Nov. 18, 2010

(54) METHOD FOR CONTROLLING GAME SYSTEM BY SPEECH AND GAME SYSTEM THEREOF

(75) Inventor: Jing LV, Shenzhen city (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: TENCENT TECHNOLOGY (SHENZHEN) COMPANY LIMITED, Shenzhen (CN)

(21) Appl. No.: 12/843,953

(22) Filed: Jul. 27, 2010

Related U.S. Application Data
(63) Continuation of application No. PCT/CN2009/073162, filed on Aug. 10, 2009.

(30) Foreign Application Priority Data
Sep. 28, 2008 (CN) 200810167764.4

(51) Int. Cl. G10L 21/00

(52) U.S. Cl. 704/275; 704/E15.001

(57) ABSTRACT

Embodiments of the present invention provide a method for controlling a game system by speech and a game system thereof. The method includes collecting a speech command, storing the speech command in association with a game command; receiving a speech command from a user during a game, searching for a game command associated with the speech command, and controlling a game system using the game command found. The game system includes a speech collecting module, an associated storage module, a speech command recognizing module and a game controlling module. The present invention can implement control of a game system using speech.

### FIELD OF THE INVENTION

The present invention relates to computer game techniques and speech techniques, and particularly, to a method for controlling a game system by speech and a game system thereof.

### BACKGROUND OF THE INVENTION

With developments of computer technologies, people tend to use computers more and more in everyday life and for entertaining, and computer game is among the most important entertaining choices. With Internet thriving, online games which combines computer games and Internet techniques are becoming more and more popular. At present, for both console games and online games, users have to use manual inputting devices, such as a mouse, a keyboard, for game operations.

Over recent years, speech techniques evolve quickly from traditional speech coding techniques into the currently widely-applied speech recognition techniques.

A statistic-based speech recognition method is a predominant speech recognition technique currently, which identifies a word to which an input speech signal corresponds based on co-occurrence probability of words derived from a large-scale true-life speech corpus.

Till now, the speech recognition techniques have not been used in the field of computer games which is closely related to leisure time of people. And current computer games still use conventional inputting devices, such as keyboard and mouse for controlling a game. A computer game system controllable by speech has yet to be seen.

### SUMMARY OF THE INVENTION

Embodiments of the present invention provide a method for controlling a game system by speech and a game system so as to control the game system by speech.

The technical scheme of the present invention is given as follows.

According to an embodiment of the present invention, a method for controlling a game system by speech is provided. The method includes:

collecting a speech command, storing the speech command collected in association with a game command;

receiving the speech command from a user during a game, searching for the game command associated with the speech command, and controlling a game system by the game command found.

According to another embodiment of the present invention, a game system is provided. The game system includes: a speech collecting module, an associated storage module, a speech command recognizing module and a game controlling module; wherein

the speech collecting module is adapted to collect a speech command and transmit the collected speech command to the associated storage module;

the associated storage module is adapted to store the received speech command in association with a game command;

the speech command recognizing module is adapted to receive the speech command sent by a user during a game, search the associated storage module for the game command associated with the speech command, and transmit the game command found to the game controlling module; and

the game controlling module is adapted to control a game system by the game command received from the speech command recognizing module.

It can be seen that embodiments of the present invention store a collected speech command in association with a game command, receive a speech command from a user during a game, search for a game command associated with the speech command, and control a game system using the game command found. By associating the speech command with the game command, speech can be used for controlling the game system, which facilitates the user to use the game system.

### BRIEF DESCRIPTION OF THE DRAWINGS

FIG. 1 is a flowchart illustrating a method for controlling a game system by speech in accordance with an embodiment of the present invention.

FIG. 2 is a flowchart illustrating a process of associating a speech command in a method for controlling a game system by speech.

FIG. 3 is a flowchart illustrating a process of identifying a speech command in a method for controlling a game system by speech.

FIG. 4 is a schematic diagram illustrating a structure of a game system in accordance with a first embodiment of the present invention.

FIG. 5 is a schematic diagram illustrating a structure of a game system in accordance with a second embodiment of the present invention.

FIG. 6 is a schematic diagram illustrating a structure of a game system in accordance with a third embodiment of the present invention.

FIG. 7 is a schematic diagram illustrating a structure of a game system in accordance with a fourth embodiment of the present invention.

### DETAILED DESCRIPTION OF THE INVENTION

The present invention will be described in detail hereinafter with reference to accompanying drawings and embodiments to make the technical solution and merits therein clearer.

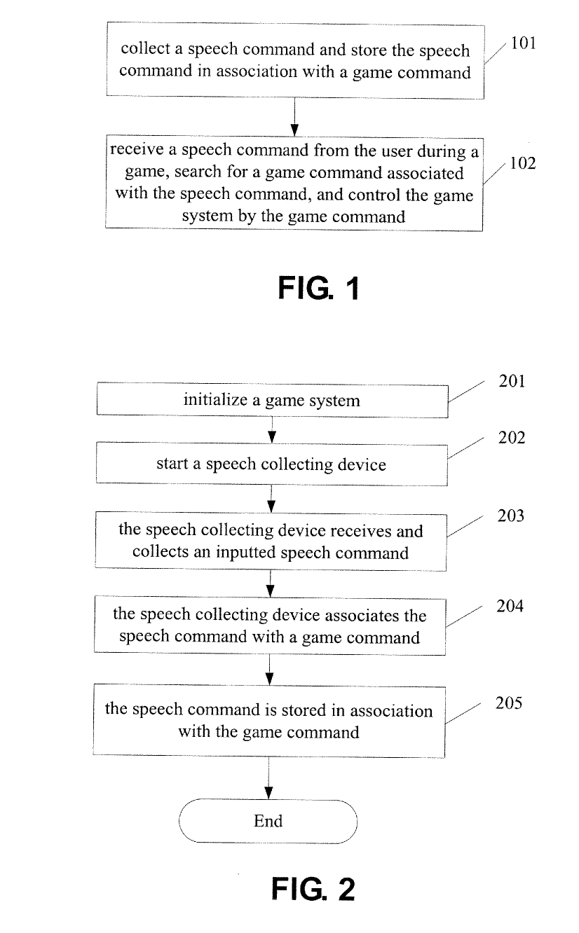

FIG. 1 is a flowchart illustrating a method for controlling a game system by speech in accordance with an embodiment of the present invention. As shown in FIG. 1, the method may include steps as follows.

In step 101, collect a speech command and store the speech command in association with a game command.

In this step, the collecting of the speech command means that a current user of a game system collects a speech command of the user him/herself. The speech command may be in a dialect or a standard pronunciation.

In step 102, receive a speech command from the user during a game, search for a game command associated with the speech command, and control the game system according to the game command.

The collecting the speech command and storing the speech command in association with the game command in step 101 are generally performed before the game is started, which specifically includes: the user selects an un-associated game command, collects a speech command using a speech collecting device (e.g., a microphone, etc.), stores the speech command collected in association with the game command selected. A game command may be associated with only one speech command or multiple speech commands.

The speech command which is associated with the game command in step 101 is a speech command spoken by the user of the game system, but not standard speech collected in batch. The standard speech collected in batch refers to speech obtained by applying a certain algorithm to a large amount of language corpus in existing speech techniques. Compared with the standard speech, the speech command collected in step 101 reflects speech characteristics of the current user more precisely, thus can improve accuracy of speech command recognition.

In addition, when at least two speech commands are stored in association with the same game command, flexibility of the speech command recognition can be increased and usability of the game system can also be improved. For example, in a card-game, if a user often uses “pass” and “not follow” for expressing the user is going to skip a current round, both the speech commands “pass” and “not follow” can be associated with the game command “skip the round”. Further, a game command may be associated with two speech commands of two users in their respective dialects. For example, when two users using the game system are from Shanghai and Guangxi respectively, the two users may use Shanghai accent and Guangxi accent respectively for pronouncing their respective speech commands which are associated with the same game command.

By storing the speech command in association with the game command, the user may establish a set of speech commands for controlling the game system. For example, in a card-game, the user collects a speech command “discard” and associates the speech command with a game command “discard a playing card”. Further, a speech command may be collected for each card or each combination of cards and be associated with a game command, e.g., a speech command “hearts” may be collected as a command for selecting a suit and be associated with a game command “select the hearts”.

There are many ways to store a speech command in association with a game command. For example, it is possible to store the speech command and the game command in different files, establish an index table which records a relation between the speech command and the game command utilizing an index of the speech command and an index of the game command in respective files. Or, it is possible to store the speech command and the game command associated with the speech command in the same file. In the above manners, the first manner establishes an index table for associating the speech command with the game command. Therefore, the relation between the speech command and the game command can be updated by updating an index number in the index table or by updating contents indicated by an index number stored in each file. Thus, the first manner has a good flexibility, but it takes more time for accessing and searching when performing speech command recognition. The second manner lacks flexibility in updating relations between the speech commands and the game commands but is less time consuming when performing speech command recognition.

When storing a speech command in association with a game command, the game command is generally firstly selected by a user, the speech command which is to be associated with the selected game command is then collected via a speech collecting module, and the speech command is stored in association with the game command. Since speech signals are generally narrow-band signals, considering speech signal characteristics, complexity and recognizing accuracy, the speech signals can be encoded by Differential Pulse Code Modulation (DPCM) before being stored.

The files storing the speech commands and/or the game commands may adopt a form of “information header+information”. The information header may include necessary fields such as type, length and abstract of the information. The information may include contents of the speech command or contents of the game command. For example, in this embodiment, a file storing the speech command and the game command is composed of “information header 1”+“speech information”+“information header 2”+“game command information”. The information header 1 includes a flag for speech command, the length of this information segment (including the information header 1 and the speech information) and parameters of the speech command. The speech information includes contents of the speech command. The information header 2 includes a flag for game command, the length of this information segment (including the information header 2 and the game command information) and parameters of the game command. The game command information includes contents of the game command. Storing the speech commands and the game commands in the form of “information header+information” can reduce the time taken for searching for a game command associated with a speech command.

Since speech command signals usually last for only a short time, generally a few seconds, the speech commands do not require large storage space, and currently-used computers can provide such storage space.

The collecting the speech command and storing the speech command in association with the game command are performed when the game is not being played. All relations between speech commands and game commands can be stored in a local configuration file. A relation can be deleted by deleting the configuration file or by deleting some contents of the configuration file. The configuration file may be the file which stores both the speech command and the game command, or the file which stores only the speech command, the file which stores only the game command and the index table.

In addition, frequently-used game commands may be pre-configured and be pre-loaded together with the associated speech commands after the game is started. In this way, after the speech command is received from the user during the game in step 202, the pre-loaded game commands and speech commands are firstly searched to find the game command associated with the received speech command. If the game command is not found in the pre-loaded game commands and the speech commands, game commands which are stored but not loaded will be searched. Through the pre-load manner, time taken for searching for frequently-used game commands can be reduced, which improves user's experience.

Error handling procedures may be performed to handle problems emerged when the game system is controlled by speech. For example, if there is no enough storage space when speech commands are collected, an alert may be prompted to inform the user of the storage space shortage. If a game command is not found when performing speech command recognition, an alert may be prompted to instruct the user to input the speech command again. If the game command found during speech command recognition is not consistent with the game logic at that moment, an error message may be prompted. For instance, given that a game logic rules that in each round, a player should discard a card outrank that discarded by his/her upstream player, then an error message may be prompted to indicate a wrong card is discarded when the card discarded by a player does not outrank that discarded by the upstream player.

In view of the foregoing, the method for controlling a game system by speech actually includes two processes: a speech command associating process and a speech command recognizing process.

FIG. 2 is a flowchart illustrating a process of associating a speech command in a method for controlling a game system by speech. As shown in FIG. 2, the process may include steps as follows.

In step 201, a game system is initialized.

In step 202, a speech collecting device is started up.

In this step, the speech collecting device may be any speech inputting device such as a microphone.

In step 203, the speech collecting device receives and collects an inputted speech command.

In step 204, the speech collecting device associates the speech command collected with a game command.

In steps 203-204, a game command to be associated with may be selected firstly, then the speech command to be associated with the game command is collected; or the speech command may be firstly collected, and then a game command to be associated with the speech command is selected.

In step 205, the speech command is stored in association with the game command, and the current process is ended.

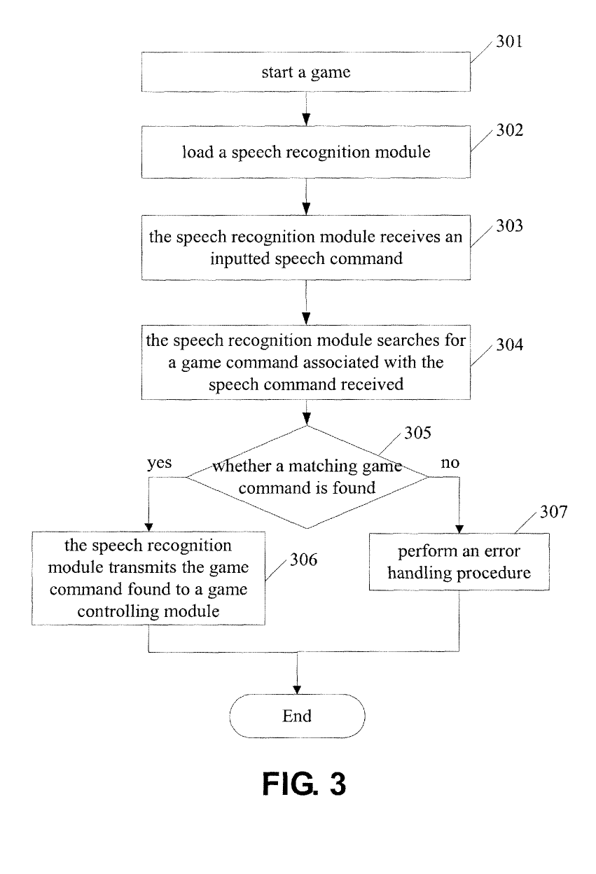

FIG. 3 is a flowchart illustrating a process of recognizing a speech command in a method for controlling a game system by speech. As shown in FIG. 3, the process may include steps as follows.

In step 301, a game is started.

In step 302, a speech recognition module is loaded.

The speech recognition module in this step is a device adapted to recognize a speech command, and has to be loaded after the game is started.

In step 303, the speech recognition module receives a speech command inputted.

In step 304, the speech recognition module searches for a game command which matches the speech command received.

In step 305, it is determined whether a game command is found, if the game command is found, step 306 will be performed; otherwise, step 307 will be performed.

In step 306, the speech recognition module transmits the game command found to a game controlling module which controls the game system according to the game command, and the current process is ended.

In this step, the game controlling module is adapted to interact with a server and control the game system.

In this step, when one speech command corresponds to one game command or multiple speech commands correspond to one game command, it is only necessary to find a matching game command of the speech command. Besides, there is also a situation that multiple speech commands respectively correspond to different game commands and the multiple game commands correspond to a same game controlling operation. At this time, the game system should find out a matching game command for each speech command and perform a proper game controlling operation based on a combination of the game commands found. For example, a speech command “hearts” corresponds to a game command “selecting a card from the hearts”, and a speech command “5” corresponds to a game command “selecting a card with value 5”, and two speech commands “discard” and “play” correspond to a game command “discard a playing card”. Then, a speech command “play hearts 5” should correspond to three game commands “selecting a card from the hearts”, “selecting a card with value 5” and “discard”. By combining the three game commands, the game control operation to be performed can be determined as discard hearts 5 of the current game user.

Before controlling a game logic using a combination of multiple game commands corresponding to multiple speech commands recognized, a priority level may be set for each speech command, or a combined sequence or priority level may be set for each game command when setting a combined game command, so that the game logic can be controlled in the way the user wishes to.

If different game controlling operations will be obtained when the game commands are combined in different sequences, a prompt of the different operations may be provided for the user to select one operation to be performed.

When combining the game commands, it may further be determined whether the game commands are suitable for the combination. For example, two speech commands “discard” and “pass” respectively corresponds to game commands “discard” and “pass”, and the game commands “discard” and “pass” cannot be combined to obtain the same game controlling operation, so when a speech command received is “discard pass”, an error prompt may be generated to inform the user that the inputted speech command is wrong.

In step 307, an error handling process is performed, and the current process is ended.

In this step, different errors should be handled by different error handling procedures. For example, when it is found that multiple game commands found cannot be combined, a prompt indicating a speech command error may be presented to the user; when a game command cannot be found, a prompt requesting the user to re-input the speech command may be presented to the user, etc.

The following is an embodiment of a game system controlled by speech.

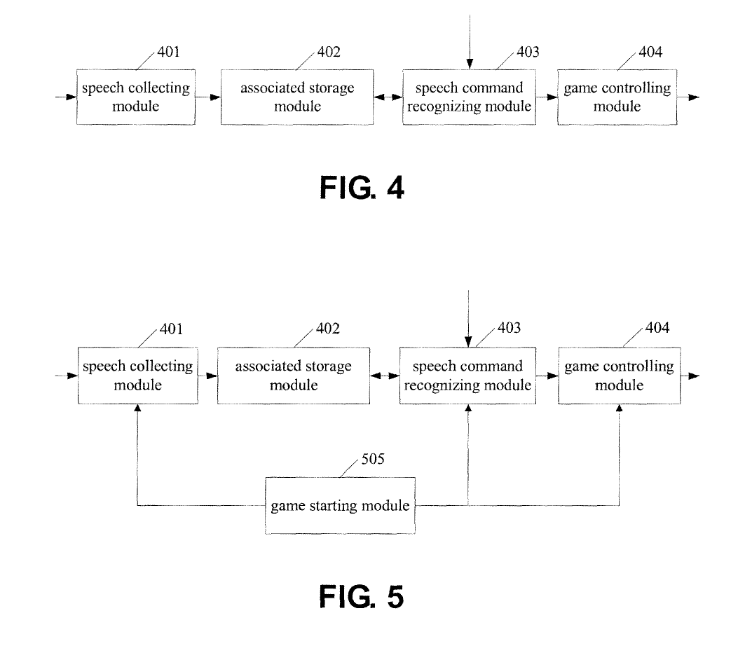

FIG. 4 is a schematic diagram illustrating a structure of a game system in accordance with a first embodiment of the present invention. As shown in FIG. 4, the game system includes a speech collecting module 401, an associated storage module 402, a speech command recognizing module 403 and a game controlling module 404.

The speech collecting module 401 is adapted to collect a speech command and transmit the collected speech command to the associated storage module 402.

The associated storage module 402 is adapted to store the speech command received in association with a game command.

The speech command recognizing module 403 is adapted to receive a speech command sent by a user during a game, search the associated storage module 402 for a game command associated with the speech command, and transmit the game command searched out to the game controlling module 404.

The game controlling module 404 is adapted to control a game system using the game command received from the speech command recognizing module 403.

FIG. 5 is a schematic diagram illustrating a structure of a game system in accordance with a second embodiment of the present invention. Based on the structure shown in FIG. 4, the game system further includes a game starting module 505.

The game starting module 505 is adapted to start a game, transmit a start indication to the speech command recognizing module 403, and close the game when the speech collecting module 401 is running. The game start module 505 may close the game via the game controlling module 404.

The speech command recognizing module 403 is further adapted to receive the start indication from the game starting module 505.

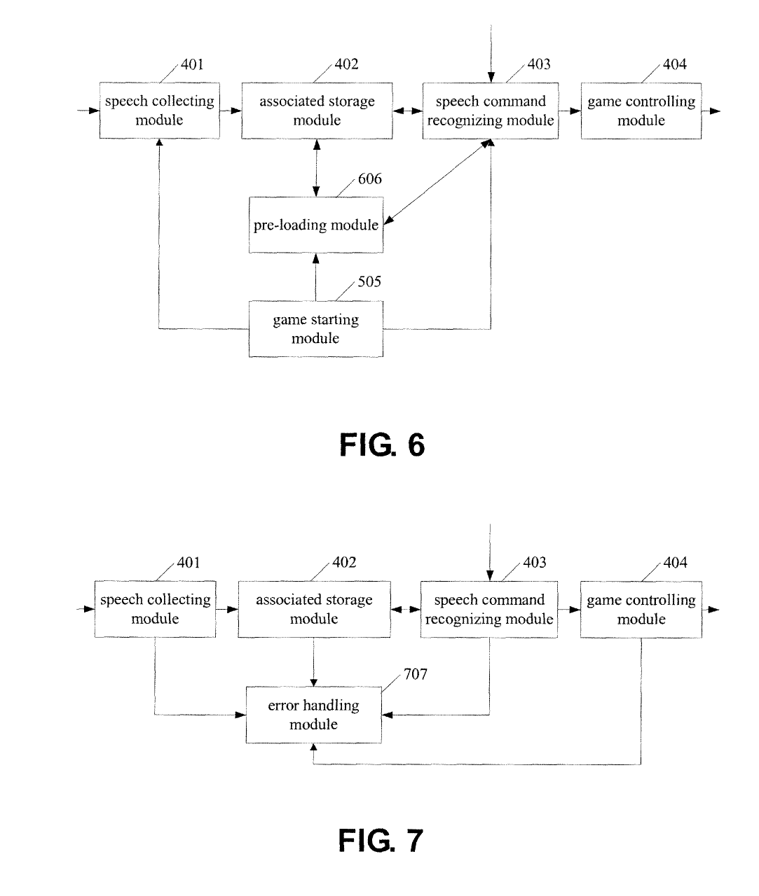

FIG. 6 is a schematic diagram illustrating a structure of a game system in accordance with a third embodiment of the present invention. Based on the system structure shown in FIG. 5, the game system further includes a pre-loading module 606.

The associated storage module 402 is further adapted to pre-configure frequently-used game commands.

The pre-loading module 606 is adapted to receive a start indication from the game starting module 505, pre-load the frequently-used game commands and speech commands associated with the frequently-used game commands.

The speech command recognizing module 403 is further adapted to search the pre-loading module 606 for the game command associated with the speech command and to search the associated storage module 402 for the game command if the game command is not found in the pre-loading module 606.

The game starting module 505 is further adapted to transmit a start indication to the pre-loading module 606 after the game is started.

FIG. 7 is a schematic diagram illustrating a structure of a game system in accordance with a fourth embodiment of the present invention. Based on the system structure shown in FIG. 4 or FIG. 5 or FIG. 6, the game system further includes an error handling module 707. FIG. 7 only shows a structure obtained by adding an error handling module 707 to the system structure shown in FIG. 4.

The error handling module 707 is adapted to receive an error indication and perform an error handling procedure. The error handling module 707 may determine an error reason by, e.g. determining from which module the error indication comes and perform different error handling procedures according to different error reasons. For example, if the error indication is from the speech command recognizing module 403, it can be determined that the error reason is fail to find a matching game command for the speech command. Accordingly, the error handling module 707 generates a prompt indicating that the matching game command is not found.

The speech collecting module 401 and/or the associated storage module 402 and/or the speech command recognizing module 403 and/or the game controlling module 404 may further transmit an error indication to the error handling module 707 when an error emerged.

According to the above technical scheme, a speech command can be collected and stored in association with a game command. When a speech command is received, a matching game command of the speech command will be searched for. Thus, the game system can be controlled by speech, which facilitates the user to use the game system.

Since the speech command collected is spoken by the current user of the game system, the speech command can reflect language characteristics of the game user well, thus a matching accuracy of speech command and the game command can be increased.

In addition, since a speech command usually lasts for a short time, e.g., for a game command “discard”, the speech command contains only one word “discard” which is short in time, the speech commands used for controlling the game system will not occupied huge storage space.

The foregoing are only preferred embodiments of the present invention and are not for use in limiting this invention, any modification, equivalent replacement or improvement made under the spirit and principles of this invention is included in the protection scope of this invention.

1. A method for controlling a game system by speech, comprising:
collecting a speech command, storing the speech command collected in association with a game command;
receiving the speech command from a user during a game, searching for the game command associated with the speech command, and controlling a game system by the game command found.

2. The method of claim 1, wherein the storing the speech command collected in association with the game command comprises: storing one game command in association with one speech command, or storing one game command in association with at least two speech commands.

3. The method of claim 1, wherein the storing the speech command collected in association with the game command comprises:
storing the speech command and the game command in different files, establishing an index table indicating a relation between the speech command and the game command based on an index of the speech command and an index of the game command in their respective files.

4. The method of claim 1, wherein the storing the speech command collected in association with the game command comprises:
storing the speech command and the game command in a same file.

5. The method of claim 3, wherein the file comprises an information header and information,
the information header stores a type and a parameter of the speech command, the information comprises contents of the speech command; or
the information header stores a type of the game command, the information comprises contents of the game command.

6. The method of claim 4, wherein the file comprises an information header and information,
the information header stores a type and a parameter of the speech command, the information comprises contents of the speech command; or
the information header stores a type of the game command, the information comprises contents of the game command.

7. The method of claim 1, wherein the collecting the speech command comprises:
collecting the speech command in a dialect or in a standard language.

8. The method of claim 7, further comprising:
encoding the speech command in the dialect or in the standard language by Differential Pulse Code Modulation (DPCM).

9. The method of claim 1, further comprising:
pre-configuring frequently-used game commands;
before receiving the speech command from the user during the game, pre-loading the frequently-used game commands and speech commands associated with the frequently-used game commands;
wherein the searching for the game command associated with the speech command comprises:
searching the pre-loaded game commands and speech commands for the game command associated with the speech command.

10. The method of claim 9, further comprising:
searching the stored speech command and associated game command if the game command is not found in the pre-loaded game commands and speech commands.

11. The method of claim 1, further comprising:
transmitting a prompt message if no game command associated with the speech command is found or if it is determined that the game command associated with the recognized speech command is not consistent with a game logic.

12. The method of claim 1, wherein multiple game commands associated with the speech command is found, the controlling the game system by the game command found comprises: combining the game commands found and controlling the game system by a combined result.

13. The method of claim 12, wherein the combining the game commands found and controlling the game system by the combined result comprises:
determining whether the game commands found can be combined according to a game logic, transmitting prompt information if the game commands cannot be combined or if there are at least two possible combined results.

14. A game system, comprising: a speech collecting module, an associated storage module, a speech command recognizing module and a game controlling module; wherein
the speech collecting module is adapted to collect a speech command and transmit the collected speech command to the associated storage module;
the associated storage module is adapted to store the received speech command in association with a game command;
the speech command recognizing module is adapted to receive the speech command sent by a user during a game, search the associated storage module for the game command associated with the speech command, and transmit the game command found to the game controlling module; and
the game controlling module is adapted to control a game system by the game command received from the speech command recognizing module.

15. The game system of claim 14, further comprising: a game starting module, wherein
the game starting module is adapted to start a game, transmit a start indication to the speech command recognizing module, and close the game when the speech collecting module is running; and
the speech command recognizing module is further adapted to receive the start indication from the game starting module.

16. The game system of claim 15, further comprising: a pre-loading module, wherein
the associated storage module is further adapted to pre-configure frequently-used game commands;
the pre-loading module is adapted to receive the start indication from the game starting module, pre-load the frequently-used game commands and speech commands associated with the frequently-used game commands;
the speech command recognizing module is further adapted to search the pre-loading module for the game command associated with the speech command, and search the associated storage module for the game command if the game command is not found in the pre-loading module; and
the game starting module is further adapted to transmit a start indication to the pre-loading module after the game is started.

17. The game system of claim 14, further comprising: an error handling module, wherein
the error handling module is adapted to receive an error indication and perform an error handling procedure; and
anyone of the speech collecting module and the associated storage module and the speech command recognizing module and the game controlling module is further adapted to transmit an error indication to the error handling module after an error emerges.
